(19) United States
(12) Patent Application Publication
(10) Pub. No.: US 2007/0282940 A1
(43) Pub. Date: Dec. 6, 2007

(54) Thread-ranking apparatus and method

(75) Inventor: Shigeaki Sakurai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/654,561

(22) Filed: Jan. 18, 2007

(30) Foreign Application Priority Data
Jun. 1, 2006 (JP) 2006-153568

(51) Int. Cl. G06F 15/16

(52) U.S. Cl. 709/202

(57) ABSTRACT

Thread-ranking apparatus includes unit collecting threads from a bulletin-board site, the thread each including a set of identifiers, articles each related to book-information items, and the book-information items, unit detecting, for each article, whether a reference part that refers to a part of a posted article of the articles is included, unit extracting the reference part, unit computing a first-article-importance degree based on number of reference parts, unit setting the first-article-importance degrees as book-information-importance degrees, unit acquiring an additional thread from the bulletin-board site, unit setting, as a second-article-importance degree, a book-information-importance degree corresponding to book information of each of the additional articles and an identifier, unit setting, as a thread-importance degree, a sum of the second-article-importance degrees to thread-importance degrees, unit rearranging the thread-importance degrees in a descending order, and unit storing, in relation to each other, the rearranged thread-importance degrees and additional threads corresponding to the thread-importance degrees.

### CROSS-REFERENCE TO RELATED APPLICATIONS

This application is based upon and claims the benefit of priority from prior Japanese Patent Application No. 2006-153568, filed Jun. 1, 2006, the entire contents of which are incorporated herein by reference.

### BACKGROUND OF THE INVENTION

1. Field of the Invention

The present invention relates to a thread-ranking apparatus and method for assisting user's decision making concerning a set of articles (thread) made along a particular theme at a bulletin board site.

2. Description of the Related Art

A large number of bulletin board sites exist on the Web, and at each site, a large number of arguments are conducted in the form of threads. Among the threads, there may exist a noteworthy thread, which will be developed into a large-scale argument that may influence even enterprise activities. However, such a thread may well be buried in the threads that are not worthy to public attention. There is a demand for extracting such an important thread.

There is a method for characterizing an article included in each thread, using an event that indicates an interest of a user, then performing the ranking of the threads based on the number of articles that include a particular event, and providing the ranked threads (see, for example, Shigeaki Sakurai and Ryohei Orihara: “A Discovery Method of Potentially Importance Thread from Bulletin Board Sites”, Proceedings of 10^{th} Heart and Mind Workshop, pp. 39-44, 2005; Shigeaki Sakurai and Ryohei Orihara: “Discovery of Important Threads using Thread Analysis Reports”, Proceedings of the IADIS International Conference WWW/Internet2006, pp. 243-248, 2006). In this method, since there is a tendency to impart a higher rank to a thread that includes a larger number of articles, it is strongly possible to overlook a thread that is noteworthy but does not contain a large number of articles.

In conventional techniques, it is strongly possible that estimation of the rank relationship between a large number of threads, or extraction of noteworthy threads therefrom cannot be performed. Moreover, even if extraction of noteworthy threads is attempted, a noteworthy thread which contains only a small number of articles may well be overlooked. This is because there is a tendency to impart higher rank to a thread containing a larger number of articles or a longer article.

### BRIEF SUMMARY OF THE INVENTION

In accordance with an aspect of the invention, there is provided a thread-ranking apparatus comprising: a collection unit configured to collect a plurality of threads from a bulletin board site, each of the threads including a set of a plurality of identifiers assigned to a plurality of authors, a plurality of articles each related to one or more book information items and posted by the authors, and the book information items; a detection unit configured to detect, for each article, whether a reference part that refers to a part of a posted article of the articles is included; an extraction unit configured to extract the reference part from articles including the reference part; a computation unit configured to compute, for each article, a first article importance degree, based on number of reference parts that refer to each article and are contained in the articles other than each article to obtain a plurality of first article importance degrees; a first setting unit configured to set the first article importance degrees as book-information importance degrees; an acquisition unit configured to acquire, from the bulletin board site, an additional thread including a plurality of additional articles; a second setting unit configured to set, as a second article importance degree of each of the additional articles, a book-information importance degree corresponding to book information of each of the additional articles and an identifier assigned to an author of each of the additional articles, and to obtain a plurality of second article importance degrees; a third setting unit configured to set, as a thread importance degree, a sum of the second article importance degrees to a plurality of thread importance degrees; a rearrangement unit configured to rearrange the thread importance degrees in a descending order when the thread importance degrees are set by the third setting unit; and a storage unit configured to store, in relation to each other, the rearranged thread importance degrees and additional threads corresponding to the thread importance degrees.

In accordance with another aspect of the invention, there is provided a thread-ranking method comprising: collecting a plurality of threads from a bulletin board site, each of the threads including a set of a plurality of identifiers assigned to a plurality of authors, a plurality of articles each related to one or more book information items and posted by the authors, and the book information items; detecting, for each article, whether a reference part that refers to a part of a posted article of the articles is included; extracting the reference part from articles including the reference part; computing, for each article, a first article importance degree, based on number of reference parts that refer to each article and are contained in the articles other than each article to obtain a plurality of first article importance degrees; setting the first article importance degrees as book-information importance degrees; acquiring, from the bulletin board site, an additional thread including a plurality of additional articles; setting, as a second article importance degree of each of the additional articles, a book-information importance degree corresponding to book information of each of the additional articles and an identifier assigned to an author of each of the additional articles, and obtaining a plurality of second article importance degrees; setting, as a thread importance degree, a sum of the second article importance degrees to a plurality of thread importance degrees; rearranging the thread importance degrees in a descending order when the thread importance degrees are set; and preparing a storage unit configured to store, in relation to each other, the rearranged thread importance degrees and additional threads corresponding to the thread importance degrees.

### BRIEF DESCRIPTION OF THE SEVERAL VIEWS OF THE DRAWING

FIG. 1 is a block diagram illustrating a thread-ranking apparatus according to an embodiment;

FIG. 2 is a flowchart illustrating part of an operation example of the thread-ranking apparatus of FIG. 1;

FIG. 3 is a flowchart illustrating the other part of the operation example of FIG. 2;

FIG. 4 is a view illustrating a learning thread example;

FIG. 5 is a view illustrating a reference part example extracted from FIG. 4 by the learning-article reference relationship analysis unit appearing in FIG. 1;

FIG. 6 is a view illustrating another reference part example extracted from FIG. 4 by the learning-article reference relationship analysis unit appearing in FIG. 1;

FIG. 7 is a view illustrating examples of reference parts and the ID of an article that is referred to, extracted from FIG. 4 by the learning-article reference relationship analysis unit appearing in FIG. 1;

FIG. 8 is a view illustrating degrees of importance computed by the learning-article reference relationship analysis unit of FIG. 1 concerning the thread of FIG. 4;

FIG. 9 is a view illustrating another learning thread example;

FIG. 10 is a view illustrating degrees of learning-article importance computed by the learning-article reference relationship analysis unit of FIG. 1 concerning the thread of FIG. 9;

FIG. 11 is a view illustrating degrees of book-information importance computed by the learning-article reference relationship analysis unit of FIG. 1 concerning the threads of FIGS. 4 and 9;

FIG. 12 is a view illustrating an estimation thread example;

FIG. 13 is a view illustrating another estimation thread example;

FIG. 14 is a view illustrating rank information acquired from FIGS. 12 and 13 by the estimation-thread-ranking unit appearing in FIG. 1;

FIG. 15 is a view illustrating a learning thread example; and

FIG. 16 is a view illustrating degree examples of book-information importance computed by the learning-article reference relationship analysis unit of FIG. 1.

### DETAILED DESCRIPTION OF THE INVENTION

A thread-ranking apparatus and method according to an embodiment of the invention will be described in detail with reference to the accompanying drawings. In the embodiment, assume that the term “thread” indicates, for example, a set of the identifiers of authors, an article written by each author concerning at least one book information, and book information. Book information is, for example, category or title information. Category information indicates, for example, “personal computer/hard disk” or “personal computer/software”. Title information indicates detailed items, such as “compatibility of hard disk” or “S1 software”, included in category information.

A description will firstly be given of the outline of the thread-ranking apparatus and method of the embodiment.

When a large number of threads exist, the thread-ranking apparatus and method of the embodiment are used to perform ranking of the threads, based on the degrees of importance of the threads, and to provide threads of higher rank to users so as to assist their decision making.

More specifically, in the thread-ranking apparatus and method of the embodiment, the threads (each thread means a set of articles written along a particular theme) accumulated at a bulletin board site are collected as data for learning. The threads will hereinafter be referred to as “learning threads (this means threads for learning)”. In the thread-ranking apparatus and method of the embodiment, the reference relationship between the articles included in each thread is analyzed to compute the importance degree of each article so that the importance degree of an article having a higher frequency of reference becomes higher.

Further, in the thread-ranking apparatus and method of the embodiment, the computed importance degrees of the articles are combined in units of combinations of book information items (such as the category of each thread and the author of each article), thereby determining the importance degree of each combination of book information items. At a bulletin board site, when a new thread is raised and an article is posted, or when an article is added to a current thread, the importance degree of the article is computed based on the importance degree of a combination of book information items belonging to the article, and the importance degree of an article to be referred to. Based on the importance degree of each article included in each thread, the importance degree of each thread is computed, whereby the ranks of all threads are determined based on their importance degrees and are provided to users.

The thread-ranking apparatus and method of the embodiment can perform ranking in which a noteworthy thread is determined to be of high importance.

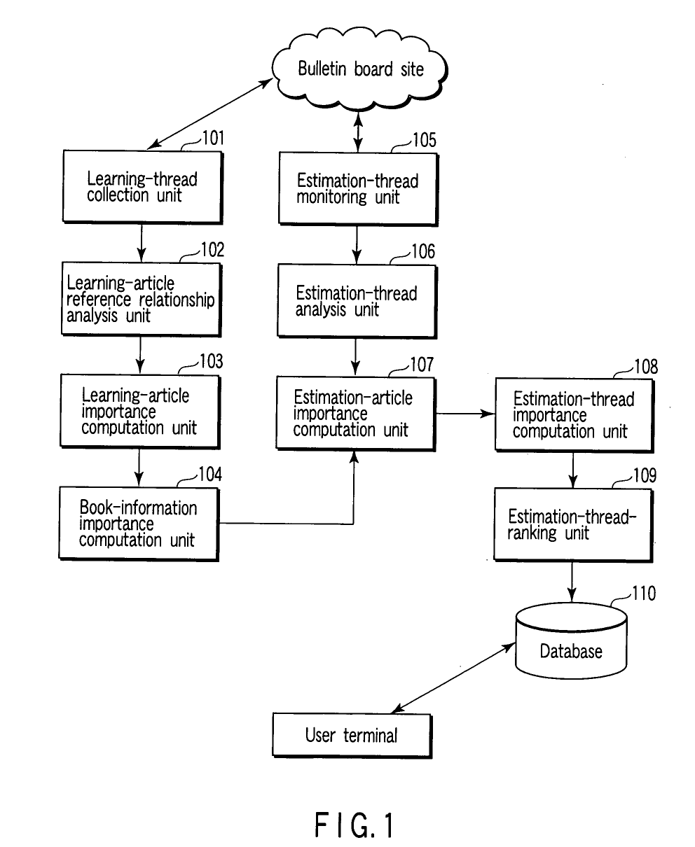

Referring to FIG. 1, the thread-ranking apparatus of the embodiment will be described. FIG. 1 shows a configuration example of the ranking apparatus for performing ranking of the threads accumulated at a bulletin board site.

As shown in FIG. 1, the thread-ranking apparatus of the embodiment comprises a learning-thread collection unit 101, learning-article reference relationship analysis unit 102, learning-article importance computation unit 103, book-information importance computation unit 104, estimation-thread monitoring unit 105, estimation-thread analysis unit 106, estimation-article importance computation unit 107, estimation-thread importance computation unit 108, estimation-thread-ranking unit 109 and database 110.

The learning-thread collection unit 101 collects a plurality of articles in units of threads from the bulletin board site. Specifically, the learning-thread collection unit 101 collects, as a learning thread, each of the threads accumulated so far at the bulletin board site.

The learning-article reference relationship analysis unit 102 analyzes the reference relationship between articles in units of threads. Specifically, the learning-article reference relationship analysis unit 102 determines the reference relationship between articles for learning (hereinafter referred to as “learning articles”) by utilizing sentences written in the learning articles.

The learning-article importance computation unit 103 computes the learning-article importance degree of each article collected based on the analysis results of the learning-article reference relationship analysis unit 102. Specifically, the learning-article importance computation unit 103 computes the learning-article importance degree of each article, only utilizing, for example, information as to whether each article contains an interrogation expression, or whether each article refers to another article.

The book-information importance computation unit 104 combines, into the importance degree (book-information importance degree) corresponding to each combination of book information items, the learning-article importance degrees computed by the learning-article importance computation unit 103 in units of combinations of book information items belonging to the threads. Specifically, the book-information importance computation unit 104 computes the importance degree of the combination of each author and each category by adding the learning-article importance degrees to the respective importance degrees of the combinations of authors and categories computed so far.

The estimation-thread monitoring unit 105 is connected to the bulletin board site to monitor posting of a new article to the site and establishment of a new thread at the site. Specifically, the estimation-thread monitoring unit 105 periodically accesses the bulletin board site to acquire, as an estimation thread, a thread to which a new article is added, or a newly raised thread, and also to acquire, as an estimation article, each article included in the estimation thread.

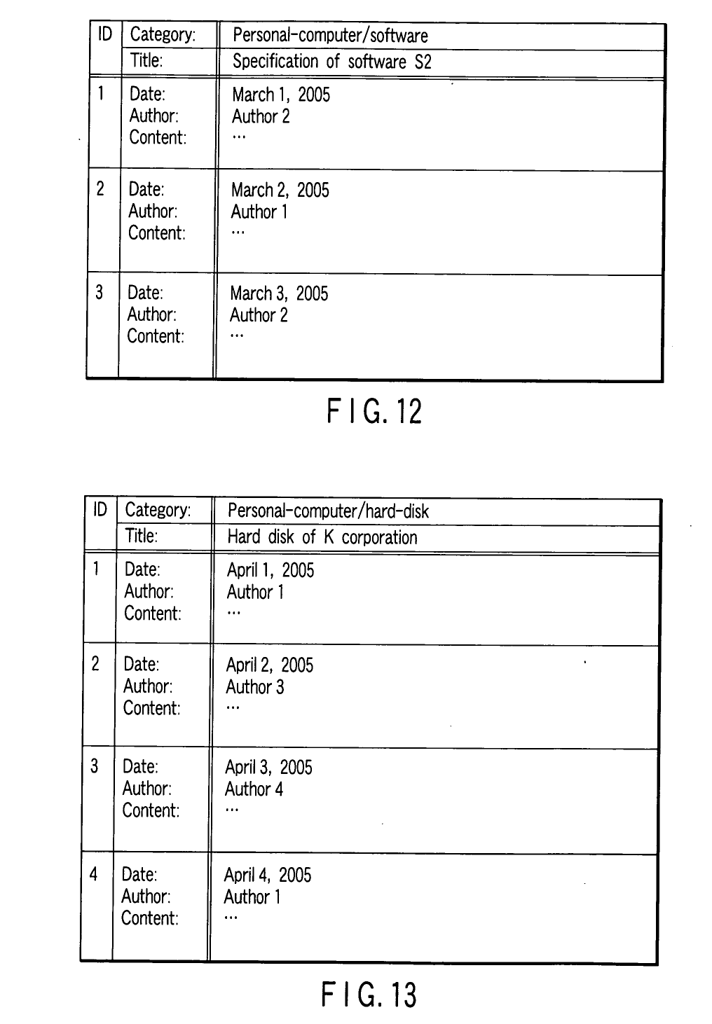

The estimation-thread analysis unit 106 determines whether the computation of the importance degree of an updated thread should be started, based on a report from the estimation-thread monitoring unit 105, thereby analyzing the book information belonging to the thread. For instance, the estimation-thread analysis unit 106 acquires the thread analysis result shown in FIG. 12 or 13.

The estimation-article importance computation unit 107 computes the importance degree of an estimation article included in an estimation thread, based on the analysis result of the estimation-thread analysis unit 106, and the importance degree acquired from the book-information importance computation unit 104.

The estimation-thread importance computation unit 108 computes the importance degree of the estimation thread, based on the importance degrees of the articles included in the estimation thread.

The estimation-thread-ranking unit 109 performs ranking of the threads, based on the thread importance degrees computed by the estimation-thread importance computation unit 108, and outputs the ranked threads to the database 110.

The database 110 stores the threads ranked by the estimation-thread-ranking unit 109. Users can browse the ranked threads by accessing the database 110.

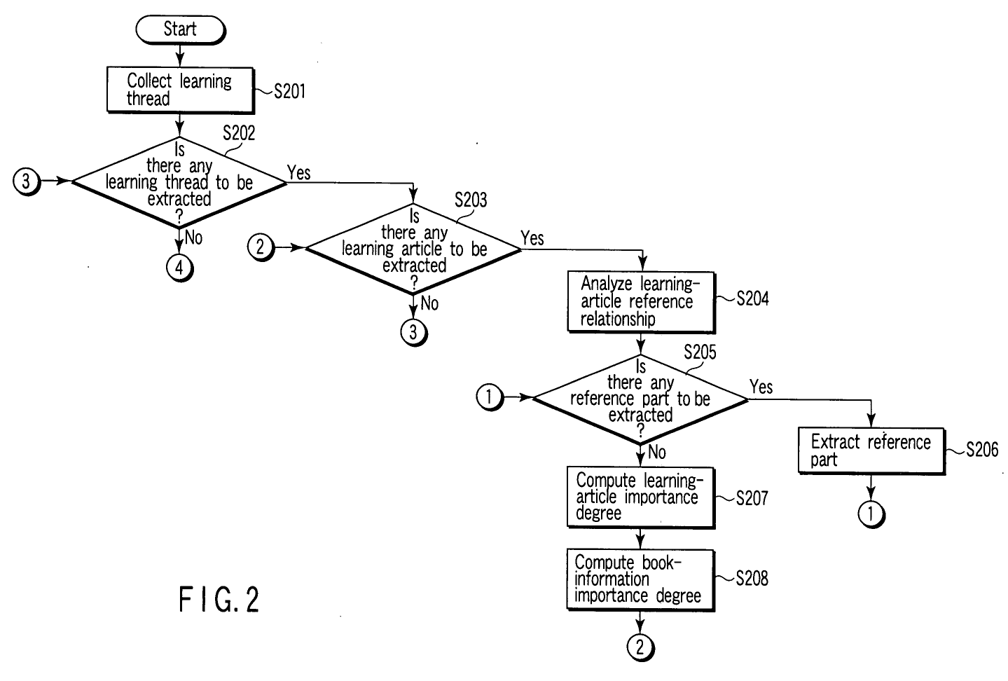

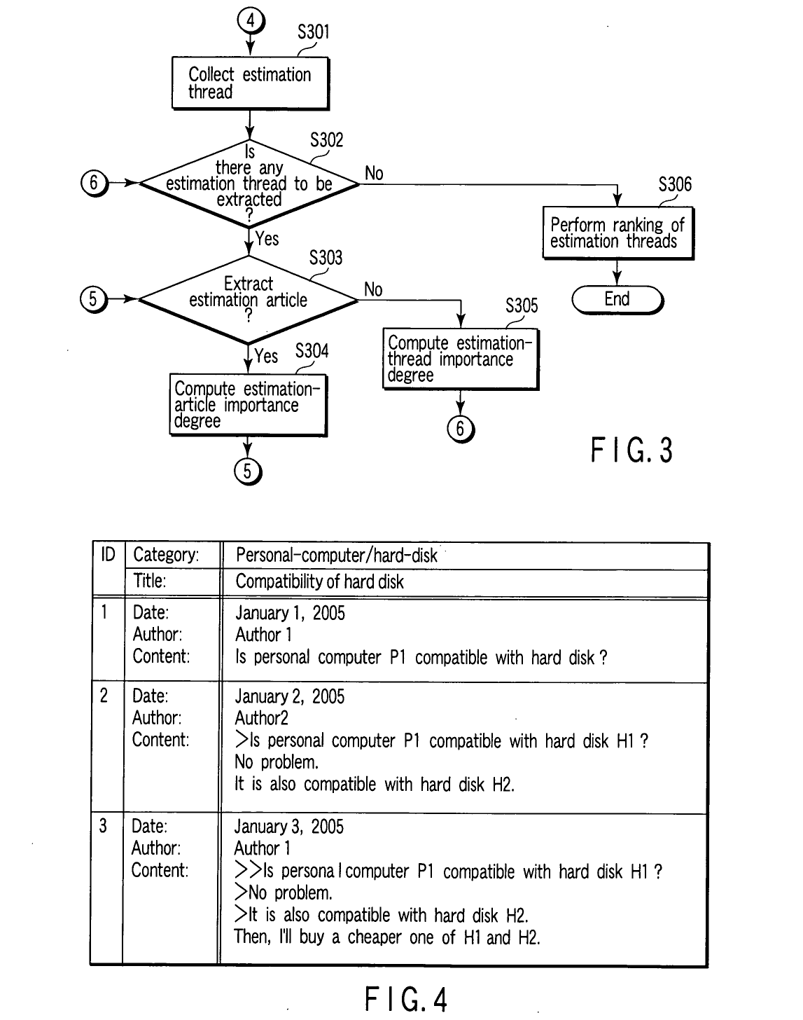

Referring then to FIGS. 2 and 3, a description will be given of an operation example of the thread-ranking apparatus of the embodiment. FIG. 2 is a flowchart illustrating the anterior half of a learning operation example of the thread-ranking apparatus of the embodiment. FIG. 3 is a flowchart illustrating the posterior half of the learning operation example. Assume here that the threads accumulated at the bulletin board site as the targets of the apparatus of the embodiment are each formed of a category as book information, a title and a plurality of articles. Also assume that each article is formed of content data as well as book information items, such as the date of posting and the author of each article.

At step S201, the learning-thread collection unit 101 downloads, from the bulletin board site, all threads accumulated so far, and collects each thread as a learning thread.

At step S202, the learning-article reference relationship analysis unit 102 extracts one from the learning threads collected at step S201. At this time, if no learning thread exists, the program proceeds to step S301. In contrast, if there is a learning thread, the program proceeds to step S203.

At step S203, the learning-article reference relationship analysis unit 102 extracts one article as a learning article from the learning thread. At this time, if there is no learning article to be extracted, the program proceeds to step S202. In contrast, if there is a learning article to be extracted, the program proceeds to step S204.

At step S204, the learning-article reference relationship analysis unit 102 analyzes the content of the learning article, and extracts therefrom a reference part, if any, that contains at least part of the content of any preceding learning article (i.e., any already posted article) included in the same thread. If such a reference part exists, the learning-article reference relationship analysis unit 102 extracts any preceding learning article corresponding to the reference part. This step will be described later in detail with reference to FIGS. 4, 5 and 6.

At step S205, the learning-article reference relationship analysis unit 102 fetches one reference part extracted at step S204. If there is no reference part to be fetched, the program proceeds to step S207, whereas if there is a reference part to be fetched, the program proceeds to step S206.

At step S206, the learning-article reference relationship analysis unit 102 determines whether the reference part contains an interrogative expression. If it contains an interrogative expression, the program returns to step S205 without extracting any learning article corresponding to the reference part. For instance, if the reference part contains an expression with the mark “?” attached to the last word of it, it is determined that the reference part contains an interrogative expression. In contrast, if no interrogative expression is contained, extraction processing is started from the first learning article included in the target thread, to thereby extract a learning article firstly detected to contain the content corresponding to the fetched reference part. An ID assigned to the extracted learning article is stored in relation to the reference part stored in the internal memory (not shown) of the learning-article reference relationship analysis unit 102. Other examples will be described later referring to FIG. 4.

At step S207, the learning-article importance computation unit 103 computes, for each learning article included in the target thread (learning thread), the number of extractions of the ID assigned to a learning article included in the target thread, which corresponds to the fetched reference part(s). Based on the computed number, importance_{A} (a) is computed using the following equation (1), to thereby acquire the importance degree of each learning article and storing it in the internal memory (not shown) of the learning-article importance computation unit 103:

importance_{A} (a)=Σ_{b}(the number of reference parts included in learning article b and acquired by referring to learning article a/the number of all reference parts included in learning article b)×ip (1)

where ip is an importance degree parameter, and importance_{A} (a) indicates the importance degree of learning article a. It is assumed that summation is performed except when the number of extractions of the ID of learning article a corresponding to the reference part(s) is 0. A specific example will be described later with reference to FIGS. 4 and 7 to 10.

At step S208, the book-information importance computation unit 104 computes the importance degree of each combination of an author and category by adding the importance degree of each learning article, computed by the learning-article importance computation unit 103, to the importance degree of the combination of each author (related to each learning article) and each category (related to each learning thread) computed so far. The unit 104 stores the resultant importance degree in its internal memory (not shown). A specific example will be described later with reference to FIGS. 4 and 8 to 11.

At step S301, the estimation-thread monitoring unit 105 collects, as an estimation thread, a thread to which a new article is added, or a newly raised thread, by periodically accessing the bulletin board site. Further, the estimation-thread monitoring unit 105 collects, as a learning article, each article from each estimation thread. Furthermore, the estimation-thread monitoring unit 105 instructs the estimation-thread analysis unit 106 to start analysis of an estimation thread, based on the total number of collected estimation articles, a preset time having elapsed from the start of collection of learning articles, and the like. After that, the estimation-thread analysis unit 106 proceeds to step S302.

At step S302, the estimation-thread analysis unit 106 extracts one from the estimation threads collected by the estimation-thread monitoring unit 105. Further, the estimation-thread analysis unit 106 extracts category information as book information corresponding to the extracted estimation thread. At this time, if there is no estimation thread to be extracted, the program proceeds to step S306, whereas if there is an estimation thread to be extracted, the program proceeds to step S303.

At step S303, the estimation-thread analysis unit 106 extracts one from the estimation articles included in the estimation thread. At this time, if there is no estimation article to be extracted, the program proceeds to step S305, whereas if there is an estimation article to be extracted, the program proceeds to step S304.

At step S304, the estimation-article importance computation unit 107 extracts author information corresponding to the estimation article extracted by the estimation-thread analysis unit 106. Further, based on the extracted author information and previously extracted category information, the estimation-article importance computation unit 107 computes the importance degree of the estimation article by referring to the importance degree of the combination of each author and category. A specific example will be described later with reference to FIGS. 11, 12 and 13.

At step S305, the estimation-thread importance computation unit 108 sums the importance degrees of the articles of the estimation thread computed by the estimation-article importance computation unit 107, thereby computing the importance degree of the estimation thread. A specific example will be described later with reference to FIGS. 11, 12 and 13.

At step S306, based on the importance degrees imparted to the estimation threads, the estimation-thread-ranking unit 109 performs ranking of the estimation threads so that a higher rank is set for an estimation thread of a higher importance degree. Further, the estimation-thread-ranking unit 109 stores the ranked estimation threads into the database 110 in the order of rank. Users can access the database 110 to browse the ranked estimation threads arranged in the order of rank. A specific example will be described later with reference to FIGS. 12, 13 and 14.

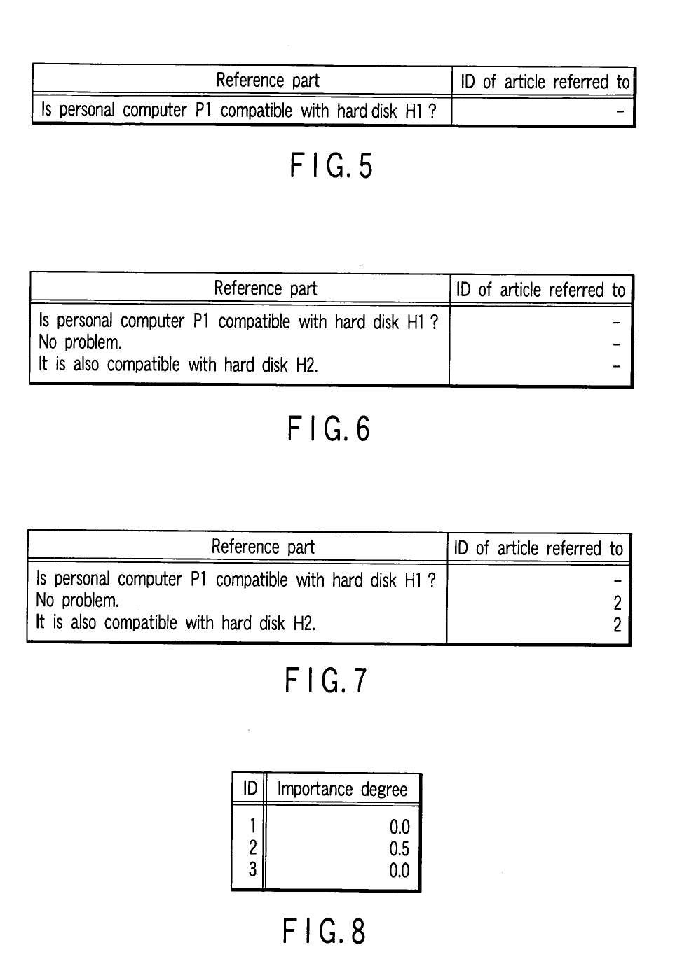

Referring now to FIGS. 4, 5 and 6, step S204 will be described, using a specific example. FIG. 4 shows a learning thread, the category and title therein belonging to the thread. More specifically, FIG. 4 shows a learning thread example that contains interrogative expressions. Identifiers IDs=1, 2 and 3 indicate the learning articles included in the learning thread example. Namely, the learning thread shown in FIG. 4 is formed of three learning articles with IDs of 1, 2 and 3. FIG. 5 shows a reference part extracted from the second learning article of FIG. 4. Similarly, FIG. 6 shows a reference part extracted from the third learning article of FIG. 4.

Assume here that the articles included in the learning thread of FIG. 4 are regarded as the learning articles collected by the learning-thread collection unit 101. Further, assume that the learning-article reference relationship analysis unit 102 determines whether each learning article contains a reference part, depending upon whether each sentence constituting the content of each learning article starts with mark “>”. Since the first learning article (ID=1) included in the learning thread of FIG. 4 does not contain a sentence starting with mark “>”, the learning-article reference relationship analysis unit 102 determines that the first learning article does not contain a reference part. In contrast, the second learning article (ID=2) in FIG. 4 contains a sentence starting with mark “>”. Therefore, the learning-article reference relationship analysis unit 102 extracts the reference part from the second learning article and stores it in its internal memory (not shown). FIG. 5 shows a state in which a sentence included in the second learning article of FIG. 4 and starting with mark “>” is stored as a reference part.

Further, in the case of the third learning article, a plurality of (three) sentences starting with mark “>” are contained. Accordingly, the learning-article reference relationship analysis unit 102 individually extracts the reference parts and stores them in the internal memory. FIG. 6 shows a state in which sentences included in the third learning article of FIG. 4 and starting with mark “>” are stored as reference parts.

Referring then to FIGS. 4 and 7, step S206 will be described, using a specific example. FIG. 7 shows the state where an ID is extracted, which indicates the learning article that is referred to by the third learning article of FIG. 4.

The first reference part (i.e., > Is personal computer P1 compatible with hard disk H1?) of the second learning article in FIG. 4 contains an interrogative expression. Therefore, the program returns to step S205 without extracting the ID of the learning article referred to. On the other hand, the second and third reference parts (i.e., > No problem. and > It is also compatible with hard disk H2.) of the third learning article in FIG. 4 contain no interrogative expressions. Therefore, the first and second learning articles of FIG. 4 are checked in this order to thereby detect, in the second learning article, the portions corresponding to the second and third reference parts. Accordingly, the learning-article reference relationship analysis unit 102 stores, into its internal memory, the ID of the second learning article as the ID of an article referred to, along with the reference parts.

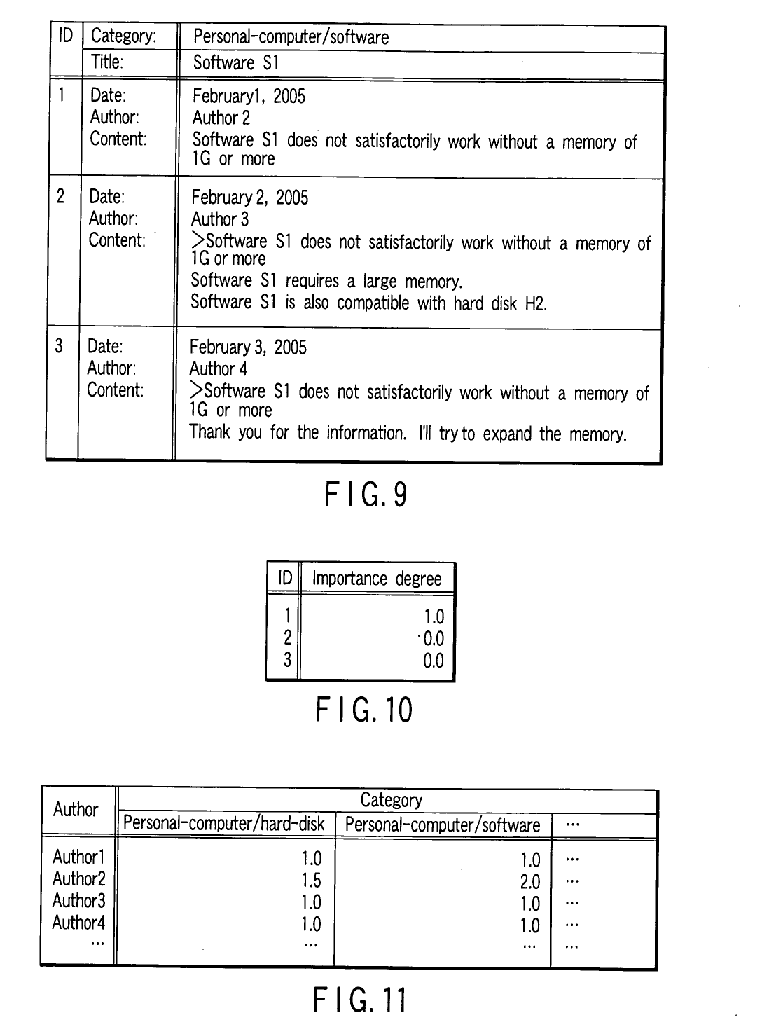

Referring then to FIGS. 4 and 7 to 10, step S207 will be described, using a specific example. FIG. 8 shows importance degrees imparted to the learning articles of FIG. 4. FIG. 9 shows a learning thread example that contains no interrogative expressions. FIG. 10 shows importance degrees imparted to the learning articles of FIG. 9.

A description will firstly be given of the learning thread of FIG. 4. Assume, for example, that ip included in the above-described expression (1) is set to 0.5. The first learning article of FIG. 4 does not contain mark “>”. The second learning article of FIG. 4 contains mark “>”, but the sentence with the mark is an interrogative. Accordingly, the sentence is not extracted as a reference part at step S206, and it is considered that the first or second learning article does not contain a reference part. On the other hand, the third learning article of FIG. 4 contains one reference part related to the first learning article and two sentences with the mark that are not interrogatives, and the ID (ID=2) of an article referred to is imparted to the two reference parts of the third learning article, as is shown in FIG. 7. Accordingly, it is considered that the number of reference parts included in the third learning article is two. Using the equation (1), the learning-article importance computation unit 103 determines that the importance degree of the second learning article is 0.5(=2/2×0.5). Further, the first or third learning article is not extracted as a reference part by another learning article, therefore the importance degrees of the first and second learning articles are set to 0. As a result, the learning-article importance degrees shown in FIG. 8 are imparted to the learning articles of FIG. 4.

A description will now be given of the learning thread shown in FIG. 9 as another example. Also in this case, ip included in the above-described expression (1) is set to 0.5. In FIG. 9, the first learning article does not contain mark “>”, therefore no reference part exists. Further, since the second and third learning articles each contain mark “>” and one sentence that is not an interrogative, they each contain one reference part. Accordingly, it is considered that the first learning article does not contain a reference part. From the article ID (ID=1) corresponding to the reference parts of the second and third learning articles, the number of reference parts in the second learning article, which refer to the first learning article, is determined to be 1. Similarly, the number of reference parts in the third learning article, which refer to the first learning article, is also determined to be 1. Using the equation (1), the learning-article importance computation unit 103 determines that the importance degree of the first learning article is 1.0(=1/1×0.5+1/1×0.5). Further, the second or third learning article is not extracted as a reference part by another learning article, therefore the importance degrees of the second and third learning articles are set to 0. As a result, the learning-article importance degrees shown in FIG. 10 are imparted to the learning articles of FIG. 9.

Alternatively, since any learning article with the importance degree of 0 is considered to be unnecessary, its importance degree may be set to −1.0. Namely, the importance degree of any unnecessary article may be reduced.

Referring then to FIGS. 4 and 8 to 11, step S208 will be described, using a specific example. FIG. 11 is a view showing the importance degrees of articles in units of authors and categories.

For instance, assume that the initial value of the importance degree for each author and category is set to 1.0. At this time, from the learning thread of FIG. 4, the learning-article importance computation unit 103 computes the learning-article importance degrees shown in FIG. 8. For the article with ID=2, the book-information importance computation unit 104 sets, as the importance degree of the combination of the author and category, 1.5 acquired by adding an importance degree of 0.5 to the initial value of 1.0. In other words, the importance degree (book information importance degree) of the combination of the author and category is 1.5 that is acquired by adding 0.5 to the importance degree 1.0 of the combination of the author of the second learning article, i.e., “Author 2”, and the category of the learning thread, i.e., “Personal-computer/hard-disk”.

Another example shown in FIG. 9 will be described. From the learning thread of FIG. 9, the learning-article importance computation unit 103 computes the learning-article importance degrees shown in FIG. 10. For the article with ID=1, the book-information importance computation unit 104 sets, as the importance degree of the combination of the author and category, 2.0 acquired by adding an importance degree of 1.0 to the initial value of 1.0. In other words, the importance degree of the combination of the author and category is 2.0 that is acquired by adding 1.0 to the importance degree 1.0 of the combination of the author of the first learning article, i.e., “Author 2”, and the category of the learning thread, i.e., “Personal-computer/software”.

Thus, in the examples shown in FIGS. 4 and 9, the importance degrees (book information importance degrees) of the combinations of authors and categories shown in FIG. 11 are stored in the internal memory of the book-information importance computation unit 104.

Referring then to FIGS. 4 and 8 to 13, step S304 will be described, using a specific example. FIG. 12 shows an estimation thread example in which the category is “Personal-computer/software”. FIG. 13 shows an estimation thread example in which the category is “Personal-computer/hard-disk”.

Assume that the book-information importance computation unit 104 has computed the importance degrees (book information importance degrees) of the combinations of authors and categories shown in FIG. 11, and that the estimation-thread analysis unit 106 has acquired analysis results, as estimation articles, concerning the threads shown in FIG. 12 and 13.

The estimation-article importance computation unit 107 computes, at 2.0, the importance degree of the first estimation article (the author is “Author 2” and the category is “Personal-computer/software”) in FIG. 12, referring to the book information importance degrees of FIG. 11 stored in the internal memory of the book-information importance computation unit 104. Similarly, the estimation-article importance computation unit 107 computes, at 1.0 and 2.0, the importance degrees of the second and third estimation articles in FIG. 12, respectively.

Further, the estimation-article importance computation unit 107 computes, at 1.0, the importance degree of the first estimation article (the author is “Author 1” and the category is “Personal-computer/hard-disk”) in FIG. 13, referring to the book information importance degrees of FIG. 11 stored in the internal memory of the book-information importance computation unit 104. Similarly, the estimation-article importance computation unit 107 computes, at 1.0, 1.0 and 1.0, as the importance degrees of the second, third and fourth estimation articles in FIG. 13, respectively.

Referring to FIGS. 11 to 13, step S305 will be described, using a specific example.

Assume that the book-information importance computation unit 104 has computed the importance degrees (book information importance degrees) of the combinations of authors and categories shown in FIG. 11, and that the estimation-thread analysis unit 106 has acquired analysis results, as estimation articles, concerning the threads shown in FIG. 12 and 13. At step S305, the estimation-thread importance computation unit 108 computes, as an estimation-thread importance degree, the sum of the estimation article importance degrees of all articles included in an estimation thread.

In the case of the thread analysis result shown in FIG. 12, the estimation-thread importance computation unit 108 determines that the sum (5.0=2.0+1.0+2.0) of the estimation article importance degrees computed at step S304 is the estimation-thread importance degree.

In the case of the thread analysis results shown in FIG. 13, the estimation-thread importance computation unit 108 determines that the sum (4.0=1.0+1.0+1.0+1.0) of the estimation article importance degrees computed at step S304 is the estimation-thread importance degree.

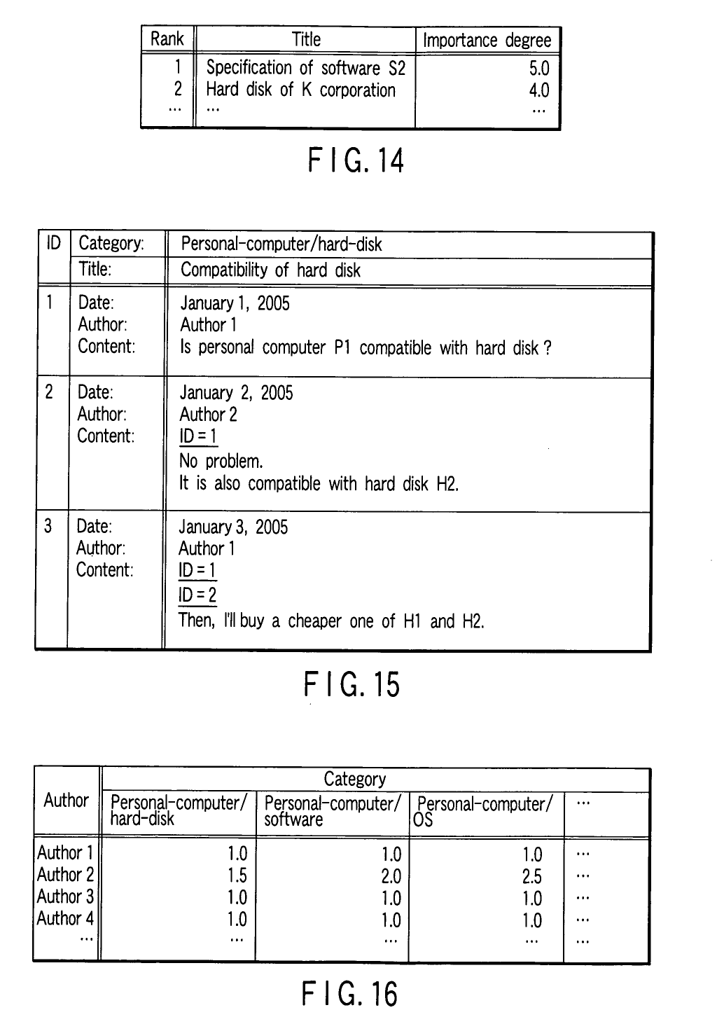

Referring to FIGS. 12 to 14, step S306 will be described, using a specific example. Assume that the estimation threads other than those shown in FIGS. 12 and 13 have an estimation thread importance degree of 2.0 or less. FIG. 14 shows output result examples concerning ranked estimation threads.

The estimation-thread-ranking unit 109 rearranges, in descending order, all estimation-thread importance degrees computed by the estimation-thread importance computation unit 108, and transfers the result to the database 110. Specifically, the estimation-thread-ranking unit 109 supplies the database 110 with the ranks in importance degree assigned in descending order to a plurality of estimation threads, and the title and importance degrees. The database 110 stores these information items and provides them to users when accessed by them for the information.

In the case of the examples shown in FIGS. 12 and 13, the estimation-thread-ranking unit 109 transfers the information shown in FIG. 14.

Thus, ranking of a plurality of estimation threads can be realized by executing each of the above-described steps, based on the estimation-article importance degrees of the estimation articles of each estimation thread. Since ranking is based on estimation-article importance degrees, even if a small number of estimation articles are included in an estimation thread, the rank of the estimation thread can be set to a higher one. Further, since each estimation-thread importance degree is computed based on a large number of learning threads, it can be computed at high accuracy, and hence appropriate estimation-thread ranking can be performed.

However, the thread-ranking apparatus incorporated in a bulletin board site is not limited to the above-described one. For instance, the learning-article reference relationship analysis unit 102, learning-article importance computation unit 103, book-information importance computation unit 104 and estimation-article importance computation unit 107 can be modified as follows:

Although in the embodiment, the learning-article reference relationship analysis unit 102 defines the reference relationship between learning articles, utilizing sentences written in the learning articles, it can also define the reference relationship, utilizing a link made by an author between an article and an associated article when the author posts the former article.

More specifically, at step S204, the learning-article reference relationship analysis unit 102 performs learning-article reference relationship analysis utilizing the link. Assume here that the learning articles shown in FIG. 15 are already posted. FIG. 15 shows a learning thread example in which the reference relationship is written in a way different from that of FIG. 4. Assume that “ID=1” and “ID=2” in FIG. 15 indicate a link to article with ID=1 and a link to article with ID=2, respectively. In this case, the learning-article reference relationship analysis unit 102 confirms whether each article includes a link, thereby defining the reference relationship between articles. Namely, in the thread example of FIG. 15, article with ID=2 refers to article with ID=1, and article with ID=3 refers to article with ID=1 and article with ID=2. Thus, FIG. 15 shows a thread identical in content to the thread of FIG. 4 and different therefrom only in the way of indicating the reference relationship.

In the embodiment, the learning-article importance computation unit 103 performs importance degree computation only utilizing the information indicating whether an interrogative sentence is included, or whether another article is referred to. However, even if similar reference is made, the importance degree of reference may differ with lapse of time. In light of this, the learning-article importance computation unit 103 may compute the importance degree by considering the lapse of time in each article.

More specifically, the learning-article importance degree computation at step S207 may be computed using the following equation (2) made in consideration of the posting dates of articles:

importance_{B} (a)=Σ_{b} (the number of reference parts included in learning article b and acquired by referring to learning article a/the number of all reference parts included in learning article b)×(1/the difference between the posting dates of learning articles a and b)×ip (2)

For instance, the importance degree of the first learning article shown in FIG. 9 will be computed. The first learning article of FIG. 9 is referred to by the second and third learning articles. Since the difference between the posting dates of the first and second learning articles is one day, and the difference between the posting dates of the first and third learning articles is two days, the importance degree of the first learning article is given as follows by the equation (2), setting ip to 0.5:

((1/1)×(1/1)+(1/1)×(1/2))×0.5=0.75

If learning articles are posted on the same day, the difference between their posting dates is set to, for example, half a day (=0.5) in the equation (2).

In the embodiment, the book-information importance computation unit 104 processes learning threads provided with a single book information item of a single category. However, it can also compute the importance degree of book information in which a plurality of categories are assigned to a single learning thread, using the combination of learning threads to each of which a plurality of categories are assigned.

More specifically, the book-information importance computation unit 104 performs learning from learning threads to each of which a plurality of categories are assigned. For instance, assume that a category ”Personal-computer/OS” is assigned to the thread example of FIG. 4, as well as the category “Personal-computer/hard-disk”, and that the category “Personal-computer/OS” is assigned to the example of FIG. 9, as well as the category “Personal-computer/software”. In this case, the learning-article importance degrees as shown in FIGS. 8 and 10 are assigned to the learning articles, and the book-information importance degrees as shown in FIG. 16 are assigned to combinations of authors and categories. FIG. 16 shows book-information importance degree examples acquired when a plurality of categories are assigned to a single thread. How to compute the book-information importance degree of the combination of, for example, “Author 2” and “Personal-computer/OS” will be described. Namely, the sum of the learning-article importance degree (0.5) of “Author 2” as the author of the second learning article in FIG. 4, and the learning-article importance degree (1.0) of “Author 2” in FIG. 9 is acquired, i.e., 0.5+1.0=1.5. Further, an initial value of 1.0 is added to the sum of 1.5. As a result, the book-information importance degree is 2.5. The other “Authors” have a learning-article importance degree of 0, therefore their book-information importance degree is equal to the initial value of 1.0.

The estimation-article importance computation unit 107 computes estimation-article importance degrees based on the authors of the estimation articles and the category of the estimation thread. However, it may analyze the reference relationship of the estimation articles, and assign importance degrees to the articles, based on the analyzed reference relationship.

More specifically, the estimation-article importance computation unit 107 computes the importance degree of the estimation thread, utilizing the following equation (3) based on the reference relationship, as well as the importance degrees of the articles included in the estimation thread:

eval(α)=Σ_{b}imp_{b}×ref_{b} (3)

where eval (α) is the estimation-thread importance degree of estimation thread α, imp_{b} is the article importance degree of article b, and ref_{b} is the number of times of reference to article b. However, assume that the number of times of reference to the last article is set to 1. In the estimation thread shown in FIG. 12, if the first article is referred to by the second and third articles, and if the second article is referred to by the third article, the numbers of times of reference to the first to third articles are 2, 1 and 1, respectively. Further, as described above, the estimation-article importance degrees of the first to third articles in FIG. 12 are 2.0, 1.0 and 2.0, respectively. Accordingly, the importance degree of the estimation thread is 7.0(=2.0×2+1.0×1+2.0×1).

Furthermore, although in the embodiment, importance degree learning and estimation-thread ranking are performed only once, they may be performed repeatedly if necessary. For instance, importance degree learning and estimation-thread ranking are performed at regular intervals. The thread-ranking apparatus incorporated in a bulletin board site may be modified in various ways without departing from the scope of the invention.

In the above-described embodiment, ranking of a large number of threads accumulated at a bulletin board site is performed in consideration of the importance degrees of the articles included in each thread, with the result that a noteworthy thread can be extracted as a thread of a higher rank.

Further, since a parameter for ranking threads is computed based on the importance degree of each article included in each thread, reduction in the rank of a noteworthy thread due to a small number of articles included therein can be suppressed. In addition, since the importance degrees of a new article and thread are computed based on the importance degrees of combinations of book information items that are modeled from a large number of articles, they can be computed at high accuracy, therefore a noteworthy thread can be extracted at high accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A thread-ranking apparatus comprising:
a collection unit configured to collect a plurality of threads from a bulletin board site, each of the threads including a set of a plurality of identifiers assigned to a plurality of authors, a plurality of articles each related to one or more book information items and posted by the authors, and the book information items;
a detection unit configured to detect, for each article, whether a reference part that refers to a part of a posted article of the articles is included;
an extraction unit configured to extract the reference part from articles including the reference part;
a computation unit configured to compute, for each article, a first article importance degree, based on number of reference parts that refer to each article and are contained in the articles other than each article to obtain a plurality of first article importance degrees;
a first setting unit configured to set the first article importance degrees as book-information importance degrees;
an acquisition unit configured to acquire, from the bulletin board site, an additional thread including a plurality of additional articles;
a second setting unit configured to set, as a second article importance degree of each of the additional articles, a book-information importance degree corresponding to book information of each of the additional articles and an identifier assigned to an author of each of the additional articles, and to obtain a plurality of second article importance degrees;
a third setting unit configured to set, as a thread importance degree, a sum of the second article importance degrees to a plurality of thread importance degrees;
a rearrangement unit configured to rearrange the thread importance degrees in a descending order when the thread importance degrees are set by the third setting unit; and
a storage unit configured to store, in relation to each other, the rearranged thread importance degrees and additional threads corresponding to the thread importance degrees.

2. The apparatus according to claim 1, wherein the extraction unit is configured to extract, as the reference part, a part included in each article and provided with a citation mark.

3. The apparatus according to claim 1, wherein the extraction unit is configured to extract, as the reference part, a part included in each article and provided with link information.

4. The apparatus according to claim 1, wherein the computation unit is configured to compute the first article importance degree, based on number of reference parts that refer to each article, are contained in the articles other than each article, and exclude an interrogative expression.

5. The apparatus according to claim 1, wherein the computation unit is configured to compute the article importance degree, based on number of reference parts that refer to each article, are contained in the articles other than each article, and exclude an interrogative expression, and also based on number of reference parts that are contained in the articles other than each article, and exclude an interrogative expression.

6. The apparatus according to claim 1, wherein the computation unit is configured to compute the article importance degree, based on a posting date of each article and posting dates of the articles of the articles other than each article.

7. The apparatus according to claim 1, wherein the third setting unit is configured to set, as the thread importance degree, a sum of values acquired by weighting each of the article importance degrees corresponding to each article, using, as a weight, number of times of reference to each article.

8. The apparatus according to claim 1, wherein the collection unit, the detection unit, the extraction unit, the computation unit, the first setting unit, the acquisition unit, the second setting unit, the third setting unit, the rearrangement unit and the storage unit are configured to perform respective operations several times.

9. A thread-ranking method comprising:
collecting a plurality of threads from a bulletin board site, each of the threads including a set of a plurality of identifiers assigned to a plurality of authors, a plurality of articles each related to one or more book information items and posted by the authors, and the book information items;
detecting, for each article, whether a reference part that refers to a part of a posted article of the articles is included;
extracting the reference part from articles including the reference part;
computing, for each article, a first article importance degree, based on number of reference parts that refer to each article and are contained in the articles other than each article to obtain a plurality of first article importance degrees;
setting the first article importance degrees as book-information importance degrees;
acquiring, from the bulletin board site, an additional thread including a plurality of additional articles;
setting, as a second article importance degree of each of the additional articles, a book-information importance degree corresponding to book information of each of the additional articles and an identifier assigned to an author of each of the additional articles, and obtaining a plurality of second article importance degrees;
setting, as a thread importance degree, a sum of the second article importance degrees to a plurality of thread importance degrees;
rearranging the thread importance degrees in a descending order when the thread importance degrees are set; and
preparing a storage unit configured to store, in relation to each other, the rearranged thread importance degrees and additional threads corresponding to the thread importance degrees.

10. The method according to claim 9, wherein extracting the reference part includes extracting, as the reference part, a part included in each article and provided with a citation mark.

11. The method according to claim 9, wherein extracting the reference part includes extracting, as the reference part, a part included in each article and provided with link information.

12. The method according to claim 9, wherein computing the first article importance degree includes computing the first article importance degree, based on number of reference parts that refer to each article, are contained in the articles that are other than each article, and exclude an interrogative expression.

13. The method according to claim 9, wherein computing the first article importance degree includes computing the first article importance degree, based on number of reference parts that refer to each article, are contained in the articles other than each article, and exclude an interrogative expression, and also based on number of reference parts that are contained in the articles other than each article, and exclude an interrogative expression.

14. The method according to claim 9, wherein computing the first article importance degree includes computing the first article importance degree, based on a posting date of each article and posting dates of the articles of the articles other than each article.

15. The method according to claim 1, wherein setting the sum of the second article importance degrees includes setting, as the thread importance degree, a sum of values acquired by weighting each of the article importance degrees corresponding to each article, using, as a weight, number of times of reference to each article.
